(19) United States
(12) Patent Application Publication
(10) Pub. No.: US 2005/0088379 A1
(43) Pub. Date: Apr. 28, 2005

(54) Image display apparatus

(75) Inventor: Masami Tsuchida, Tsurugashima-shi (JP)

Correspondence Address: MCGINN & GIBB, PLLC, 8321 OLD COURTHOUSE ROAD, SUITE 200, VIENNA, VA, 22182-3817, US

(73) Assignee: Pioneer Corporation, Tokyo (JP)

(21) Appl. No.: 10/968,993

(22) Filed: Oct. 21, 2004

(30) Foreign Application Priority Data
Oct. 24, 2003 (JP) 2003-364068

(51) Int. Cl. G09G 3/30; G09G 3/10

(52) U.S. Cl. 345/76

(57) ABSTRACT

An image display apparatus is disclosed. The image display apparatus comprises a display panel in which are arranged a plurality of display cells each having an emission element; a driving unit which generates a data signal based on a grayscale value of an image signal and applies the data signal to the display cell to cause the emission element to emit light; a driving time measurement unit which measures a cumulative driving time of the emission element; a table memory which stores a compensation coefficient for compensation for aging of the emission element with respect to the cumulative driving time; and an adjustment circuit which uses the compensation coefficient to adjust the grayscale value of the image signal, for each of the display cells.

### BACKGROUND OF THE INVENTION

1. Field of the Invention

This invention relates to an image display apparatus for driving a display panel having self-emissive elements such as LEDs (light-emitting diodes) and EL elements (electroluminescent elements).

2. Description of the Related Art

In general, display apparatus having self-emissive elements such as EL elements do not require a backlight, and have advantages of easily offering thin profile, lightweight, low power consumption and a wide angle of visibility over LCDs (liquid crystal displays). In particular, display apparatus with organic EL elements have advantages of high brightness, wide viewing angle, and rapid display response. However, the light emission efficiency (brightness-current density characteristic) of organic EL elements is known to degrade with the passage of driving time. When organic EL elements are driven with a constant voltage, in addition to the degradation of light emission efficiency, the current density-voltage characteristic of the organic EL elements is also degraded, so that as driving time elapses the driving current gradually decreases, and the drop in light emission efficiency is also large. On the other hand, when organic EL elements are driven with a constant current, the driving voltage rises with the passage of driving time, and change of the emission brightness can be limited to the change due primarily to the decrease of the light emission efficiency of the organic EL elements.

Conventional technology to compensate for the degradation of self-emissive elements has been disclosed in, for example, Japanese Patent Kokai No. 2001-13903. The driving apparatus of this patent publication performs constant-voltage driving of self-emissive elements, and has a degradation information generation circuit which generates degradation information indicating the state of degradation of self-emissive elements, and a driving pulse width adjustment circuit which adjusts the pulse widths of constant-voltage signals applied to the self-emissive elements, based on the above degradation information. This driving pulse width adjustment circuit measures the time elapsed either from manufacture of the self-emissive elements or from some point in time after manufacture, and generates degradation information according to this elapsed time; however, the rate of progression of characteristic degradation of self-emissive elements can vary according to the environment of use of the display apparatus, the driving conditions and other factors, and moreover the characteristics of all self-emission elements formed within the display panel do not necessarily undergo degradation at the same rate, so that differences in the emission brightness among pixels may increase with the passage of driving time, and unevenness in display brightness can become more prominent.

### SUMMARY OF THE INVENTION

In view of the foregoing, it is an object of this invention to provide an image display apparatus which accurately compensates for the characteristics of emissive elements which have degraded with the passage of driving time, and which is capable of achieving uniform display brightness.

According to a first aspect of the invention, there is provided an image display apparatus for driving a display panel to cause light emission in response to an input image signal. The image display apparatus comprises a display panel in which are arranged a plurality of display cells each having at least one emission element; a driving unit which generates a data signal based on a grayscale value of the image signal and applies the data signal to the display cell to cause the emission element to emit light; a driving time measurement unit which measures a cumulative driving time of the emission element; a table memory which stores a compensation coefficient for compensation for aging of the emission element with respect to the cumulative driving time of the emission element; and an adjustment circuit which uses the compensation coefficient from the table memory to adjust the grayscale value of the image signal, for each of the display cells.

According to a second aspect of the invention, there is provided an image display apparatus for driving a display panel to cause light emission in response to an input image signal. The image display apparatus comprises a display panel in which are arranged a plurality of display cells each having at least one emission element; a driving unit which generates a data signal based on a grayscale value of the image signal and applies the data signal to the display cell to cause the emission element to emit light; a driving time measurement unit which measures a cumulative driving time of the display panel; a table memory which stores a compensation coefficient for compensation for aging of the emission element with respect to the cumulative driving time of the display panel; an adjustment circuit which uses the compensation coefficient from the table memory to adjust the grayscale value of the image signal, for each of the display cells; one or a plurality of monitoring emission elements formed within the display panel, which emit light in response to a driving current; a signal measurement unit which measures a monitoring signal indicating a current state of the monitoring emission elements; and a compensation coefficient calculation unit which calculates the compensation coefficient at each predetermined interval based on the monitoring signal and stores the compensation coefficient in the table memory.

Further features of the invention, its nature and various advantages will be more apparent from the accompanying drawings and the following detailed description of the preferred embodiments.

### BRIEF DESCRIPTION OF THE DRAWINGS

FIG. 1 is a block diagram schematically illustrating a configuration of an image display apparatus which is a first embodiment of this invention;

FIG. 2 schematically illustrates an example of an equivalent circuit of a display cell within an organic EL panel;

FIG. 3 is a graph illustrating one example of grayscale values of 8-bit image signals;

FIG. 4 is a timing chart schematically illustrating various signal waveforms when display cells are driven;

FIG. 5 illustrates a graph representing an example of the relation between a cumulative driving time of an organic EL element (element driving time) and a driving current;

FIG. 6 illustrates a graph representing an example of the relation between a panel driving time and the element driving time;

FIG. 7 schematically illustrates a graph representing the stored contents of a table memory;

FIG. 8 is a flowchart schematically illustrating a procedure for grayscale control processing;

FIG. 9 illustrates a graph representing an example of grayscale values of 9-bit adjusted signals;

FIG. 10 is a timing chart schematically illustrating the various signal waveforms when display cells are driven;

FIG. 11 illustrates a graph used for interpolation processing;

FIG. 12 is a block diagram schematically illustrating a configuration of the image display apparatus which is a modified example of the first embodiment;

FIG. 13 is a block diagram schematically illustrating a configuration of the image display apparatus which is a second embodiment of this invention;

FIG. 14 schematically illustrates one example of an equivalent circuit of a monitoring cell;

FIG. 15 is a flowchart schematically illustrating a first procedure for compensation coefficient calculation processing;

FIGS. 16A and 16B illustrate graphs of driving current with respect to the panel driving time and compensation coefficient with respect to the element driving time;

FIG. 17 illustrates a graph representing an example of the contents of a degradation rate table;

FIG. 18 is a flowchart schematically illustrating a second procedure for compensation coefficient calculation processing;

FIG. 19 is a block diagram schematically illustrating a configuration of the image display apparatus which is a third embodiment of this invention;

FIG. 20 is a flowchart schematically illustrating a procedure of compensation coefficient calculation processing;

FIGS. 21A and 21B illustrate graphs of driving current with respect to the panel driving time and compensation coefficient with respect to the element driving time; and

FIG. 22 illustrates a graph representing an example of contents of a degradation rate table.

### DETAILED DESCRIPTION OF THE INVENTION

Various embodiments of this invention will now be described.

1. First Embodiment

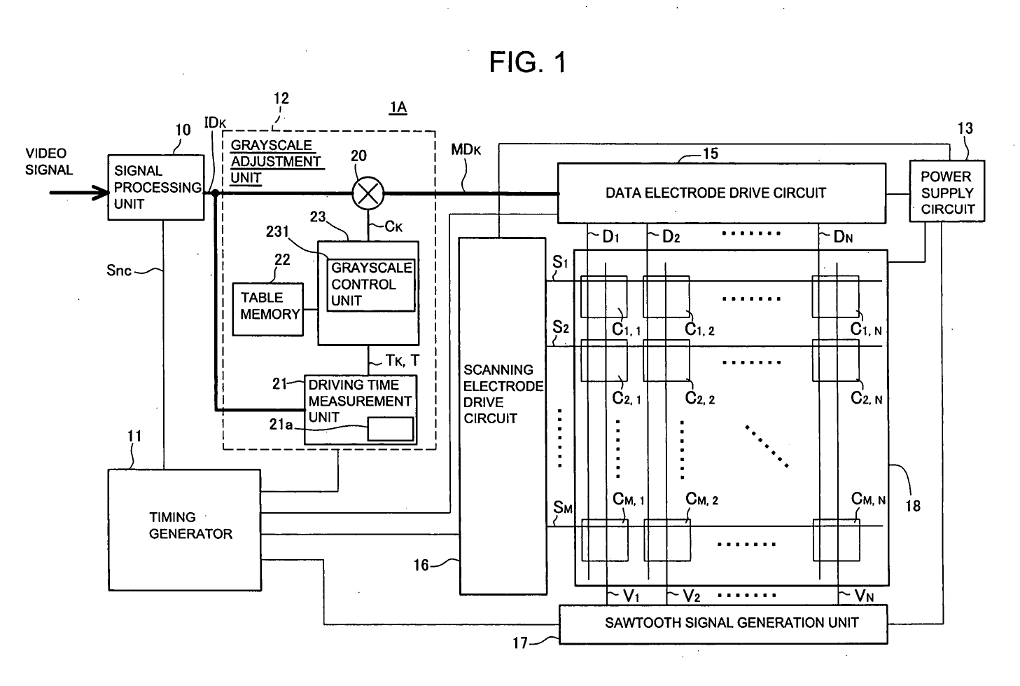

FIG. 1 is a block diagram schematically illustrating the configuration of the image display apparatus 1A which is a first embodiment of this invention. The image display apparatus 1A comprises a signal processing unit 10, timing generator 11, grayscale adjustment unit 12, power supply circuit 13, data electrode drive unit 15, scanning electrode drive unit 16, sawtooth signal generation unit 17, and organic EL panel (display panel) 18.

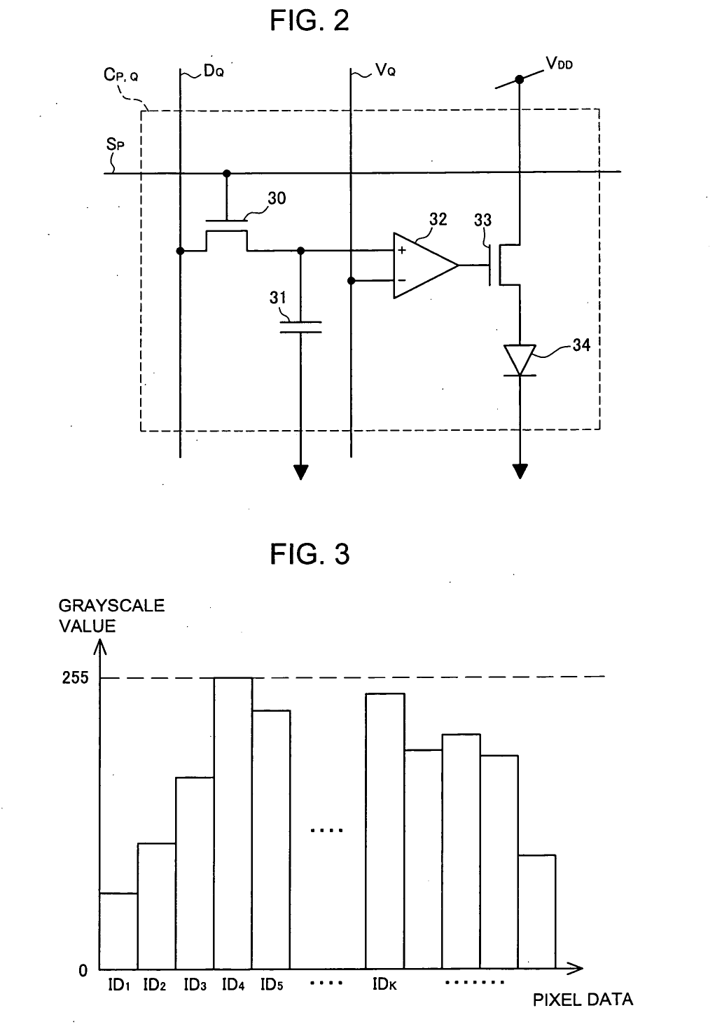

On a substrate of the above organic EL panel 18 are formed M wired scanning electrodes S₁, S₂, . . . , S_{M} connected to the scanning electrode drive unit 16 (where M is an integer equal to or greater than 2), and N wired data electrodes D₁, D₂, . . . , D_{N} connected to the data electrode drive unit 15 (where N is an integer equal to or greater than 2), so as to intersect with a gap between the scanning electrodes S₁, S₂, . . . , S_{M} and the data electrodes D₁, D₂, . . . , D_{N}. At the points of intersection of the data electrodes D₁, D₂, . . . , D_{N} with the scanning electrodes S₁, S₂, . . . , S_{M} are formed M×N display cells C_{1,1}, C_{1,2}, . . . , C_{1,N}, . . . , C_{M,N}, each having at least one organic EL element (light-emitting element). On a substrate of this organic EL panel 18 are also formed reference electrodes V₁, V₂, . . . , V_{N}, so as to extend up to the display cells C_{1,1} to C_{M,N}, which transmit sawtooth signals. In this embodiment, organic EL elements are adopted, but the light-emitting elements in this invention are not limited to organic EL elements, and any light-emitting elements with a brightness varying according to the supplied current or the applied voltage may be used. FIG. 2 schematically illustrates one example of an equivalent circuit of a display cell C_{P,Q} (where P is an integer from 1 to M, and Q is an integer from 1 to N) of the organic EL panel 18.

Each of the above display cells C_{1,1} to C_{M,N} may comprise a single pixel, or, when a panel configuration for color display or for area-ratio grayscale is adopted, a plurality of cells among the display cells C_{1,1} to C_{M,N} may form a single pixel. For example, three display cells forming a single pixel may respectively have R (red), G (green) and B (blue) color filters; or, through combinations of lighting and extinction of three display cells forming one pixel, 2-bit grayscale (area-ratio grayscale) may be obtained.

The timing generator 11 uses the sync signal Snc supplied by the signal processing unit 10 to divide or multiply the frequency of the reference clock signal. Clock signals are generated indicating the operation timing for each processing block, and are supplied to the grayscale adjustment unit 12, data electrode drive unit 15, scanning electrode drive unit 16, and sawtooth signal generation unit 17.

The signal processing unit 10 samples the video signal supplied from the outside, processes the sampled video signal, separates this into an image signal and a sync signal Snc, and supplies the sync signal Snc to the timing generator 11, while supplying a digital image signal of a prescribed bit length to the grayscale adjustment unit 12. FIG. 3 illustrates a graph representing an example of the grayscale value of an 8-bit image signal ID_{K} (where K is a positive integer). According to FIG. 3, the image signals ID₁, ID₂, . . . , ID_{K} each have grayscale values in the range from 0 to 255.

The grayscale adjustment unit 12 comprises a multiplication circuit (adjustment circuit) 20, control unit 23, table memory 22, and driving time measurement unit 21. The grayscale value of an image signal ID_{K} input from the signal processing unit 10 is adjusted in display cell units to create an adjusted signal MD_{K} of a prescribed bit length, which is supplied to the data electrode drive unit 15. Here, the bit length of the adjusted signal MD_{K} is set to be larger than the bit length of the image signal ID_{K}. The specific operation of this grayscale adjustment unit 12 will be explained below.

The power supply circuit 13 is a block which generates power supply voltages from the voltage provided by an external power supply (not shown), and supplies this to the data electrode drive unit 15, scanning electrode drive unit 16, and sawtooth signal generation unit 17. The data electrode drive unit 15, scanning electrode drive unit 16 and sawtooth signal generation unit 17 use the power supply voltage supplied by the power supply circuit 13 and clock signals supplied by the timing generator 11 to generate signals which are applied to the data electrodes D₁ to D_{N}, the scanning electrodes S₁ to S_{M}, and the reference electrodes V₁ to V_{N}, respectively.

The data electrode drive unit 15 sequentially samples and shifts pixel data of the adjusted signals MD_{K} transmitted from the grayscale adjustment unit 12, and holds the pixel data for each horizontal line. Then, the data electrode drive unit 15 latches the pixel data, generates a data signal having an amplitude proportional to the grayscale value of the data for each pixel, and supplies this signal to each of the data electrodes D₁ to D_{N} with a prescribed timing.

Next, referring to FIG. 2, a display cell C_{P,Q} comprises thin film transistors (hereinafter referred to as “TFTs”) 30, 33 which are active devices and one type of field effect transistor, an organic EL element 34, a capacitor 31, and a comparator 32. In the selection TFT 30, the gate is connected to the P-th scanning electrode S_{P}, the source is connected to the Q-th data electrode D_{Q}, and the drain is connected to the positive (+) terminal of the comparator 32 and to one of the terminals of the capacitor 31. The other terminal of the capacitor 31 is connected to a reference potential (ground potential). The negative (−) terminal of the comparator 32 is connected to the reference electrode V_{Q}. In the driving TFT 33, the gate is connected to the output terminal of the comparator 32, the drain is provided with the power supply potential V_{DD} from the power supply circuit 13, and the source is connected to the anode of the organic EL element 34. The cathode of the organic EL element 34 is provided with a reference potential (ground potential).

Next, basic operation of the above-described display cells C_{P,Q} will be explained below. The scanning electrode drive unit 16 sequentially applies scanning pulses to the scanning electrodes S₁ to S_{M}, based on the clock signal applied by the timing generator 11. When a scanning pulse is applied to a scanning electrode S_{P}, the selection TFT 30 connected to this scanning electrode S_{P} is switched on. In the period over which the selection TFT 30 is switched on, when data signals are supplied to a data electrode D_{Q}, the data signals are supplied to the capacitor 31 via the selection TFT 30, charge accumulates in the capacitor 31, and thus data is written. By this means, a voltage substantially equal to the voltage of the data signal is applied to the positive terminal of the comparator 32. The comparator 32 compares the potential of the positive terminal with the potential of the negative terminal, and in the period over which the positive terminal potential is equal to or higher than the negative terminal potential, a high-level driving pulse DP is output, whereas over the period in which the potential of the positive terminal is less than the negative potential, a low-level driving pulse DP is output.

When the high-level driving pulse DP is applied to the gate of a driving TFT 33, a conducting channel is formed between the source and drain of the driving TFT 33, and the driving TFT 33 is switched on. At this time a source-drain current flows in the driving TFT 33, and this current is supplied to the organic EL element 34 as the driving current, causing the organic EL 34 to emit light. On the other hand, when the low-level driving pulse DP is applied to the gate of the driving TFT 33, the driving TFT 33 is switched off, and the driving current supplied to the organic EL element by the driving TFT 33 is shut off, so that the organic EL element 34 does not emit light. It is preferable that the gate-source voltage Vgs is high enough that the current flowing in the organic EL element 34 is not easily affected by varying in the characteristic of the driving TFT 33, causing the driving TFT 33 to operate in the saturation region.

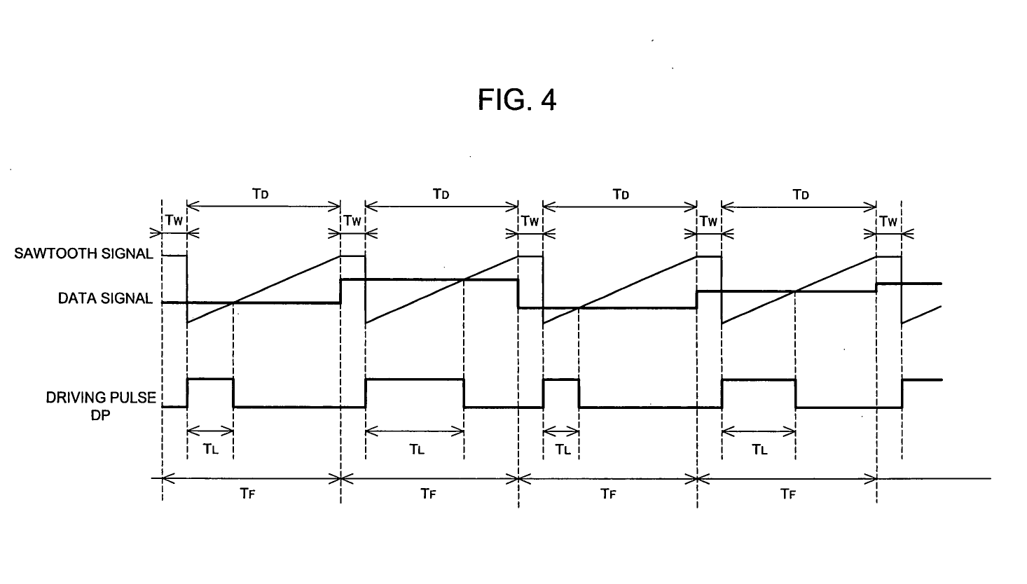

FIG. 4 is a timing chart schematically illustrating various signal waveforms when a display cell C_{P,Q} is driven. Referring to FIG. 4, within a frame period T_{F}, the selection TFT 30 is switched on during the data writing period T_{W}, and data is written. At the same time, during this period T_{W} the voltage of the sawtooth signal supplied to the reference electrode V_{Q} is maintained at the high level V_{H}. In the driving period T_{D} which follows the data writing period T_{W}, the voltage of the sawtooth signal is gradually raised from an initial level of V₀ to a high level V_{H}. Here, the initial level V₀ of the sawtooth signal is set so as to be substantially equal to the voltage of the data signal corresponding to a brightness level of zero. In each driving period T_{D}, the comparator 32 applies a high-level driving pulse DP to the gate of the driving TFT 33 such that the voltage of the data signal is equal to or higher than the voltage of the sawtooth signal. As a result, the driving current is supplied to the organic EL element 34 throughout a period T_{L} which substantially matches the pulse width of the driving pulse DP, causing the organic EL element 34 to emit light.

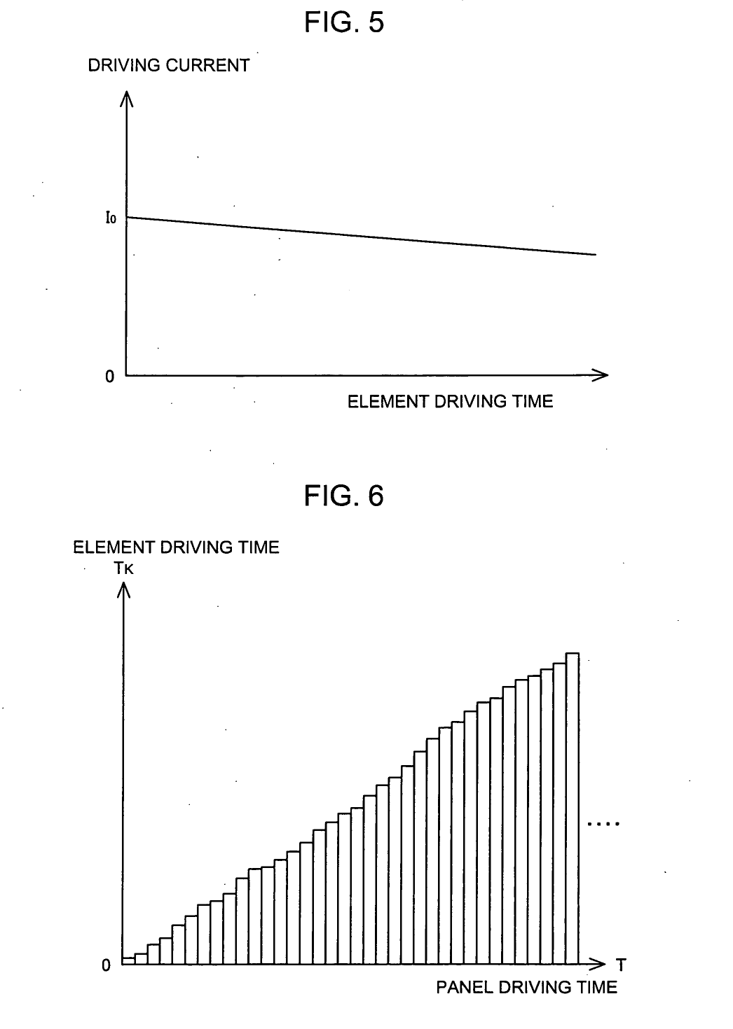

As described above, when an organic EL element 34 is driven with a constant voltage, the driving current gradually decreases with aging of the characteristics of the organic EL element 34 as the driving time of the organic EL element 34 accumulates, so that the emission brightness declines. FIG. 5 illustrates an example of the relation between the cumulative driving time (hereinafter referred to as an “element driving time”) obtained by totaling the driving time of an organic EL element 34, and the driving current flowing in the organic EL element 34. With the passage of element driving time, the driving current declines gradually, starting from an initial value I₀. For example, when the initial value of the driving current is 10.00 μA (microAmperes), the driving current after 100 hours of element driving time have elapsed is 9.90 μA, the driving current becomes 9.85 μA after 200 hours have elapsed, and the driving current becomes 7.00 μA after 10,000 hours have elapsed.

Next, the configuration and operation of the grayscale adjustment unit 12 will be explained. The driving time measurement unit 21 sequentially captures image signals ID_{K} output from the signal processing unit 10, uses the grayscale values of the pixel data of these image signals ID_{K} to measure the element driving time for each display cell, and holds the measurement result in the measurement memory 21a. For example, when image signals having grayscale values of “10”, “4”, “100”, “10” are supplied in sequence to a certain display cell, the element driving time for the display cell is a time proportional to 124 (=10+4+100+10). For convenience in explanation, the element driving time of the K-th display cell among the display cells C_{1,1} to C_{M,N} of the organic EL panel 18 is represented by the symbol T_{K}, and the cumulative driving time (hereinafter referred to as a “panel driving time”) obtained by totaling the driving time for the organic EL panel 18 is represented by the symbol T. As shown in FIG. 6, with the passage of the panel driving time T the element driving time T_{K} increases.

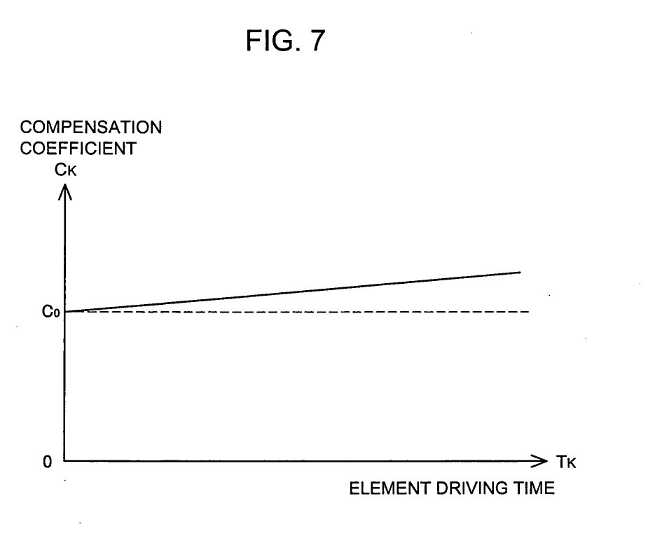

The table memory 22 is a lookup table memory which stores compensation coefficients for compensating for change with time in emission elements according to the element driving time. FIG. 7 schematically illustrates a graph representing the stored contents of the table memory 22. This table memory 22 stores a compensation coefficient C_{K} corresponding to element driving time T_{K}. When the control unit 23 stores the element driving time T_{K} of the K-th display cell in the table memory 22, the table memory 22 executes processing to return to the control unit 23 the compensation coefficient C_{K} corresponding to the driving time T_{K}.

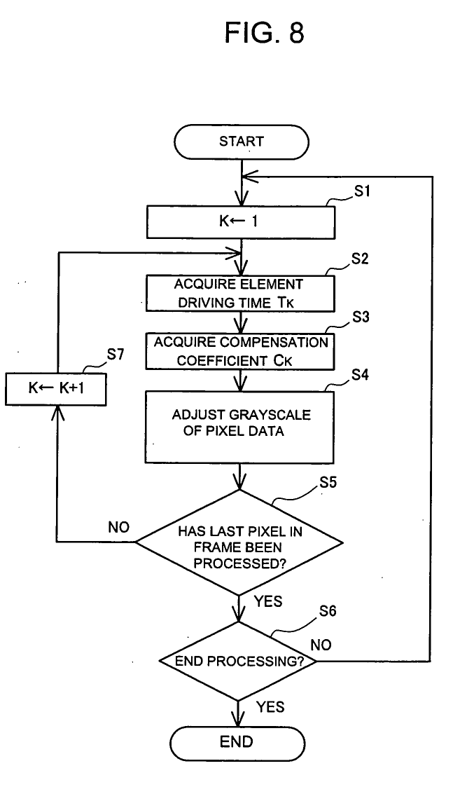

The control unit 23 comprises a grayscale control unit 231. This grayscale control unit 231 is a block which executes grayscale control processing to acquire the element driving time T_{K} of the display cell corresponding to an input image signal ID_{K} from the driving time measurement unit 21, acquire the compensation coefficient C_{K} corresponding to the acquired element driving time T_{K} from the table memory 22, and apply these to the multiplication circuit 20. Below, grayscale control processing will be explained in detail, referring to the flowchart of FIG. 8. For convenience of explanation, in this grayscale control processing each display cell is assumed to comprise one pixel, and the image signal ID_{K} is assumed to be input to the grayscale adjustment unit 12 in frame units.

First, the grayscale control unit 231 sets the pixel number K to the initial value (=1), in accordance with input of the first pixel data (step S1), and then, referring to the driving time measurement unit 21, acquires the element driving time T_{K} for the display cell C_{K} corresponding to the K-th pixel data (step S2). Next, the grayscale control unit 231 refers to the table memory 22 and acquires the compensation coefficient C_{K} corresponding to the element driving time T_{K} (step S3), and adjusts the grayscale value of the pixel data by applying the compensation coefficient C_{K} to the multiplier circuit 20 (step S4). The multiplier circuit 20 multiplies the compensation coefficient C_{K} from the grayscale control unit 231 by the input image signal ID_{K} to generate an adjusted signal MD_{K} which is supplied to the data electrode drive unit 15. In the next step S5, the grayscale control unit 231 judges whether the final pixel in the frame has been subjected to adjustment processing. If it is judged that the final pixel in the frame has not been adjusted, the grayscale control unit 231 increments the pixel number K (step S7), and the procedure of step S2 is repeated for the K+1th pixel data. On the other hand, if it is judged that the final pixel in the frame has been adjusted, the grayscale control unit 231 judges whether to end processing or not, based on a control signal applied by the timing generator 11 (step S6). If it is judged that processing will not end, the grayscale control unit 231 repeats step S1 in the grayscale control processing for the next input frame. On the other hand, if it is judged in step S6 that processing will end, the grayscale control unit 231 ends the above grayscale control processing.

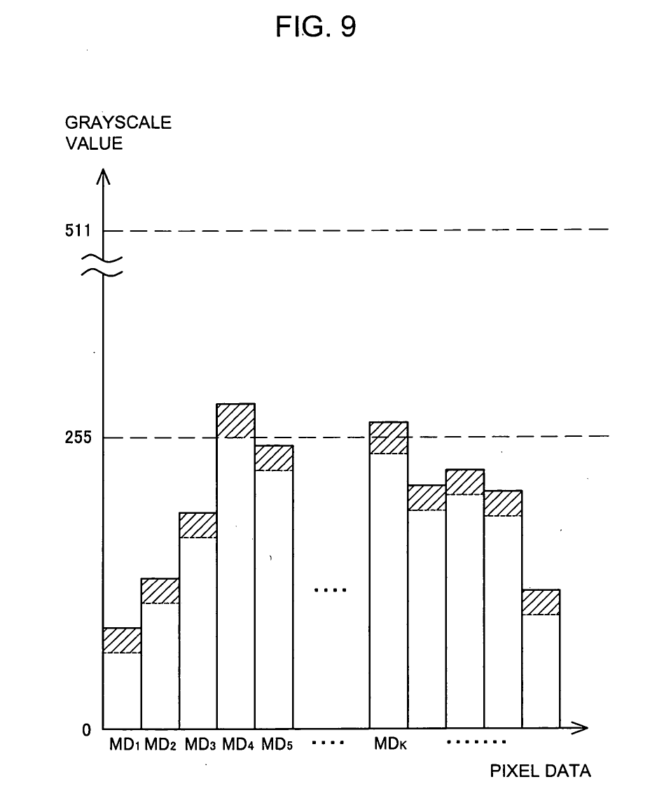

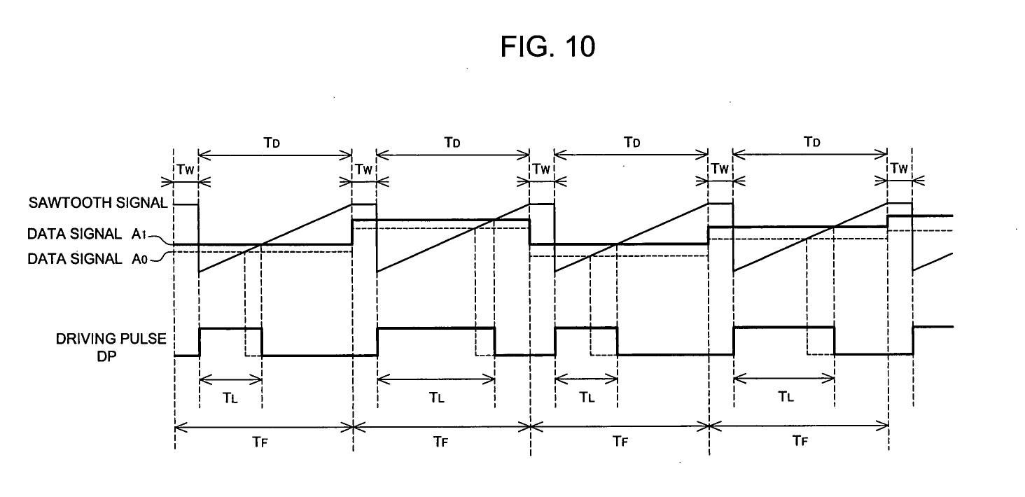

For example, when image signals ID₁, ID₂, . . . , ID_{K} having the grayscale values shown in FIG. 3 are input to the grayscale control unit 231, the grayscale values of the adjusted signals MD₁, MD₂, . . . , MD_{K} are increased by the amounts indicated by the shading according to the respective compensation coefficients C₁, C₂, . . . , C_{K}, as shown in FIG. 9. FIG. 10 is a timing chart schematically illustrating an example of various signal waveforms when a display cell C_{P,Q} (FIG. 2) is driven. Referring to FIG. 10, compared with the data signal A₀ at the beginning of driving, the level of the data signal A₁ at the time when degradation of the emission element characteristic has occurred is higher, and the pulse width T_{L} of the driving pulse DP is modulated so as to be longer. Because the time during which the driving current is supplied to the organic EL element 34 is lengthened according to the increase in pulse width of the driving pulse DP, the decline in emission brightness of the organic EL element 34 can be compensated by increasing an emission period.

In place of measuring the element driving time T_{K} for each display cell, the element driving time for each of a plurality of display cells may be measured. For example, when one pixel comprises three display cells, the sum of the cumulative driving times of these three display cells can be counted as the element driving time. When the element driving time of the first display cell is 3 hours, the element driving time of the second display cell is 4 hours, and the element driving time of the third display cell is 5 hours, then the element driving time of these first through third display cells can be set equal to 12 hours (=3+4+5 hours).

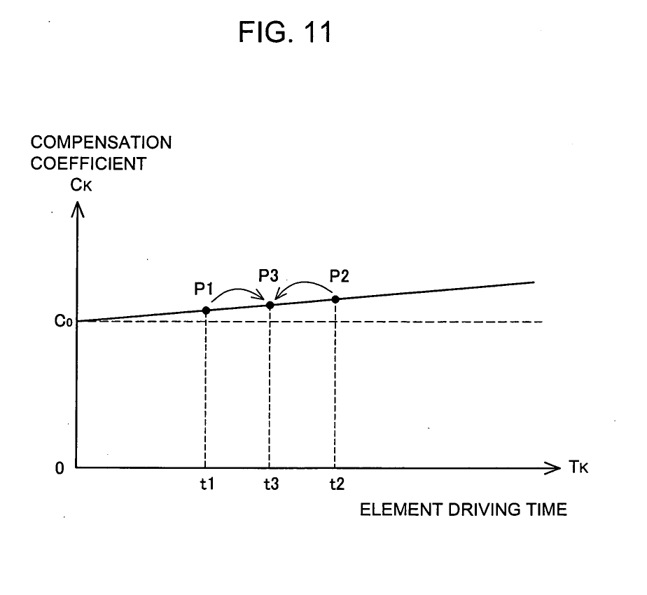

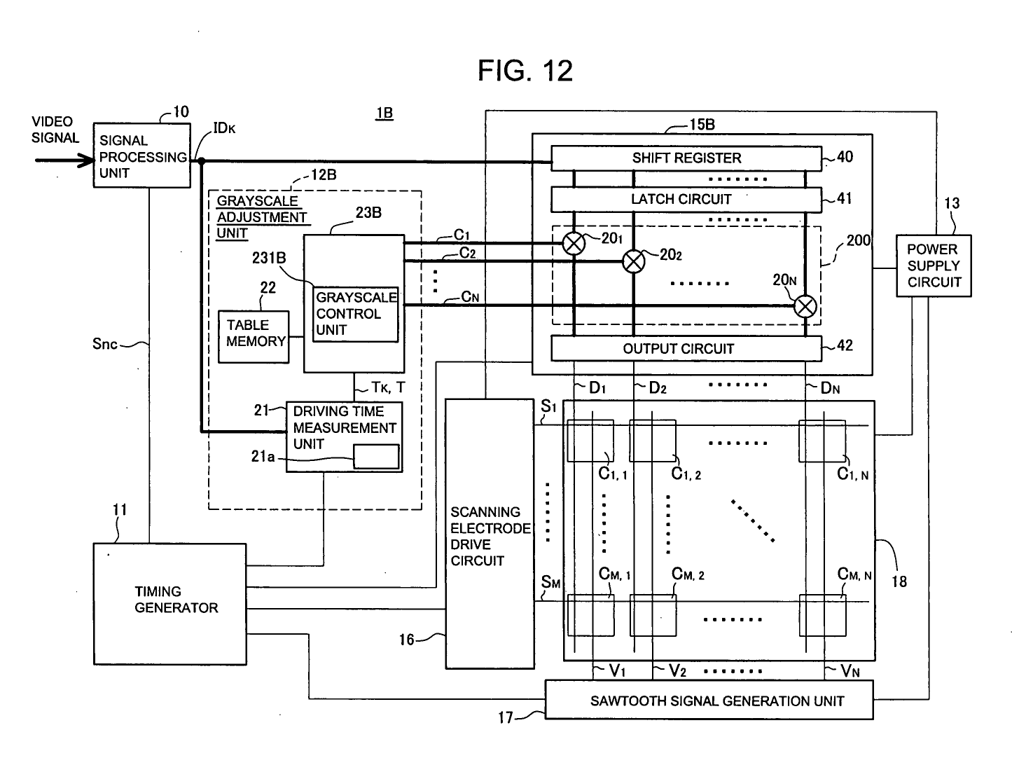

The grayscale control unit 231 has a function to acquire at least two compensation coefficients from the table memory 22, and to use the acquired compensation coefficients to interpolate any required compensation coefficients corresponding to element driving times. For example, with an S tap digital filter (where S is an integer equal to or greater than 2), one interpolated compensation coefficient can be calculated using S compensation coefficients. FIG. 11 illustrates a graph used for interpolation processing. The table memory 22 stores the compensation coefficients of the two points P1 and P2 for element driving times T_{K} of t1 and t2. The compensation coefficient of point P3 for the element driving time T_{K} of t3 is not stored. In this case, the grayscale control unit 231 can generate the interpolated compensation coefficient C_{K} of point P3 from the compensation coefficients of the two points P1 and P2 by a linear interpolation method. By means of this interpolation processing, high-precision interpolated compensation coefficients C_{K} can be obtained, and/or, the storage capacity required for the table memory 22 can be reduced.

As described above, the image display apparatus 1A of the first embodiment employs the driving time measurement unit 21 to measure in realtime the element driving time, acquires compensation coefficients corresponding to element driving times from the table memory 22, and uses the compensation coefficients to adjust the grayscales of image signals in display cell units. Accordingly, change in characteristics of the emission element with driving time can be accurately compensated in display cell units, change in the brightness of the organic EL panel 18 can be suppressed, and uniform display brightness can be obtained.

In the above first embodiment, the grayscale of image signals ID_{K} inputted to the data electrode drive unit 15 are adjusted. Instead of this, a modified example can also be adopted in which grayscale of image signals are adjusted after input to the data electrode drive unit 15. FIG. 12 is a block diagram schematically illustrating the configuration of the image display apparatus 1B of this modified example. This image display apparatus 1B has the same configuration and same functions as the image display apparatus 1A of the above embodiment, except for the grayscale adjustment unit 12B and data electrode drive unit 15B. The grayscale adjustment unit 12B comprises a table memory 22, control unit 23B and driving time measurement unit 21; the functions of the table memory 22 and driving time measurement unit 21 are the same as the functions of the corresponding elements of the grayscale adjustment unit 12 in the above first embodiment.

The control unit 23B comprises a grayscale control unit 231B. This grayscale control unit 231B acquires, from the driving time measurement unit 21, the element driving times T₁ to T_{N} of display cells corresponding to the image signals ID₁ to ID_{N} of one horizontal line, and from the table memory 22 acquires the compensation coefficients C₁ to C_{N} corresponding respectively to the acquired element driving times T₁ to T_{N}. The grayscale control unit 231B executes grayscale control processing to apply the N compensation coefficients C₁ to C_{N} acquired from the table memory 22 to the multiplier unit 200 incorporated into the data electrode drive unit 15.

Image signals ID₁ to ID_{N} which are output from the signal processing unit 10 and input to the data electrode drive unit 15B are captured in the shift register 40 and shifted, and are then output in parallel to the latch circuit 41. The latch circuit 41 latches image signals of each horizontal line outputted in parallel from the shift register 40, and then outputs them in parallel to the multiplier circuits 20₁ to 20_{N} of the multiplier unit 200. The N multiplier circuits 20₁ to 20_{N} multiply the compensation coefficients C₁ to C_{N} by the respective N image signals outputted from the latch circuit 41 to generate adjusted signals which are output in parallel to the output circuit 42. The output circuit 42 generates N data signals based on the grayscale values of the adjusted signals, and these are supplied to the data electrodes D₁ to D_{N}.

2. Second Embodiment

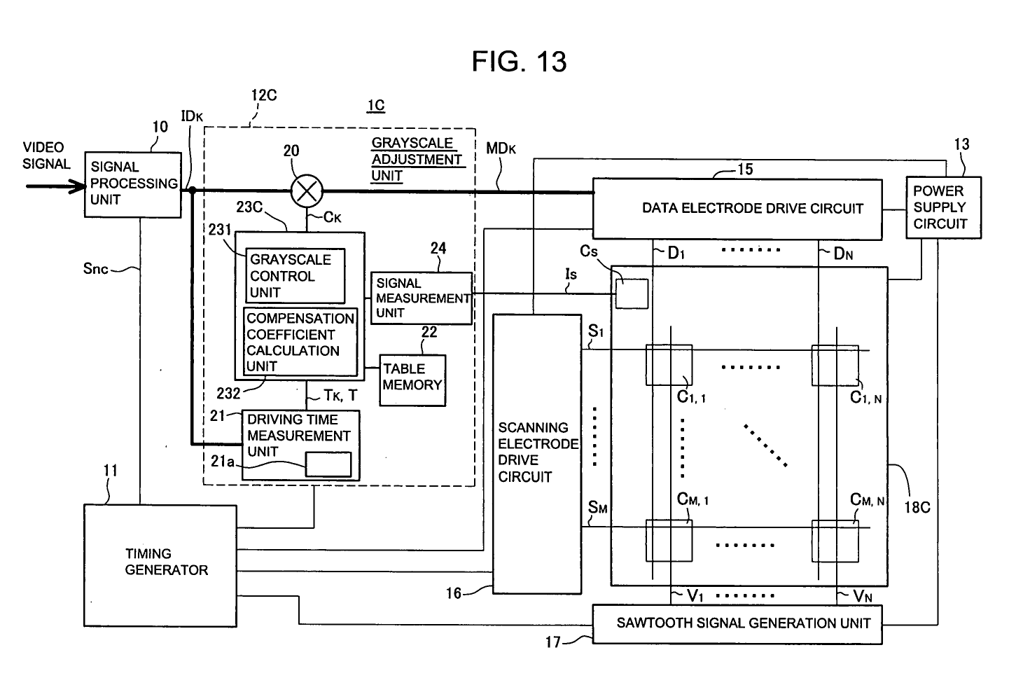

Next, a second embodiment of this invention will be described. FIG. 13 is a block diagram schematically illustrating a configuration of the image display apparatus which is the second embodiment. The image display apparatus 1C comprises a signal processing unit 10, timing generator 11, grayscale adjustment unit 12C, power supply circuit 13, data electrode drive unit 15, scanning electrode drive unit 16, sawtooth signal generation unit 17, and organic EL panel (display panel) 18C. In FIG. 13, constituent elements referred to by the same reference numeral as in FIG. 1 have the same configuration and same functions as the constituent elements of the first embodiment described above. Detailed explanation of such constituent elements is omitted.

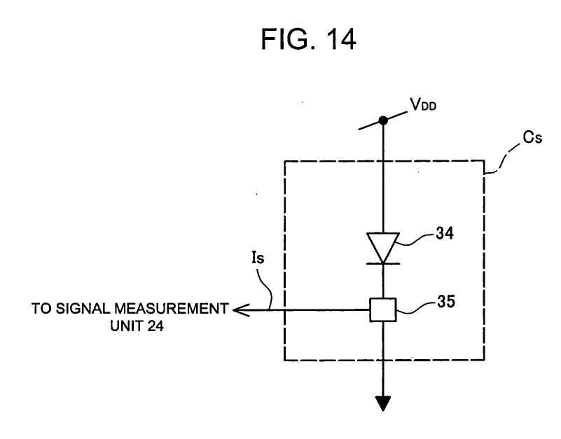

The organic EL panel 18C has substantially the same configuration as the organic EL panel 18 of the above first embodiment, except for a monitoring cell Cs formed on the substrate together with the display cells C_{1,1} to C_{M,N}. The monitoring cell Cs includes either one or a plurality of monitoring emission elements. FIG. 14 schematically illustrates one example of the equivalent circuit of the monitoring cell Cs. This monitoring cell Cs includes one organic EL element 34 constantly driven over a period of time (panel driving time) to drive the organic EL panel 18C. The power supply potential V_{DD} is applied to the anode of the organic EL element 34, and a reference potential is applied, via the detection circuit 35, to the cathode. The detection circuit 35 detects the driving current flowing in the organic EL element 34, and outputs a monitoring signal Is representing the detection result.

The grayscale adjustment unit 12C comprises a multiplication circuit 20, control unit 23C, table memory 22, driving time measurement unit 21, and signal measurement unit 24. The control unit 23C comprises a grayscale control unit 231 and compensation coefficient calculation unit 232; the operation of the grayscale control unit 231 is the same as the operation of the grayscale control unit 231 in the above first embodiment (FIG. 1). That is, the grayscale control unit 231 executes grayscale control processing to acquire the element driving times T_{K} of display cells corresponding to input image signals ID_{K} from the driving time measurement unit 21, acquire compensation coefficients C_{K} corresponding to the element driving times T_{K} from the table memory 22, and provide these to the multiplication circuit 20.

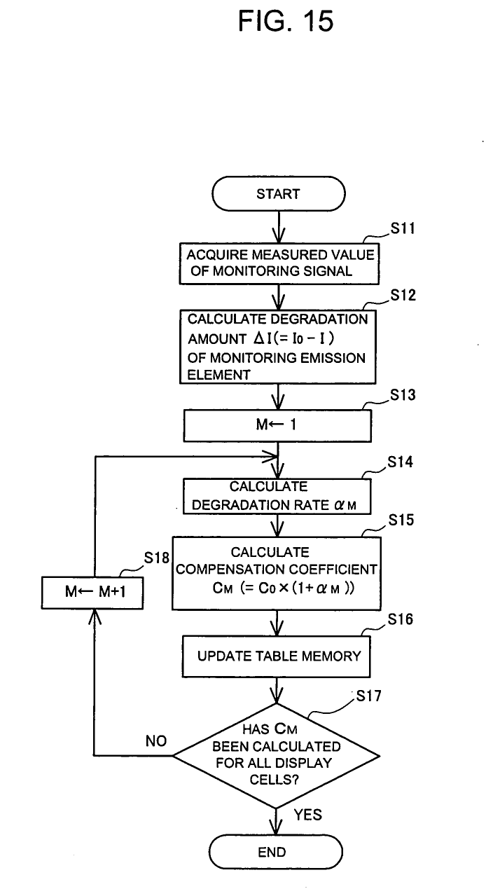

The signal measurement unit 24 measures the driving current flowing in the monitoring emission element based on the monitoring signal I_{S} supplied by the monitoring cell Cs, and applies the measured value to the compensation coefficient calculation unit 232. The compensation coefficient calculation unit 232 is a block which executes compensation coefficient calculation processing to calculate compensation coefficient for each display cell at each predetermined interval, based on the measured value from the signal measurement unit 24, and to update the stored contents of the table memory 22 to the newly calculated compensation coefficients. Below, first compensation coefficient calculation processing will be explained referring to the flowchart of FIG. 15.

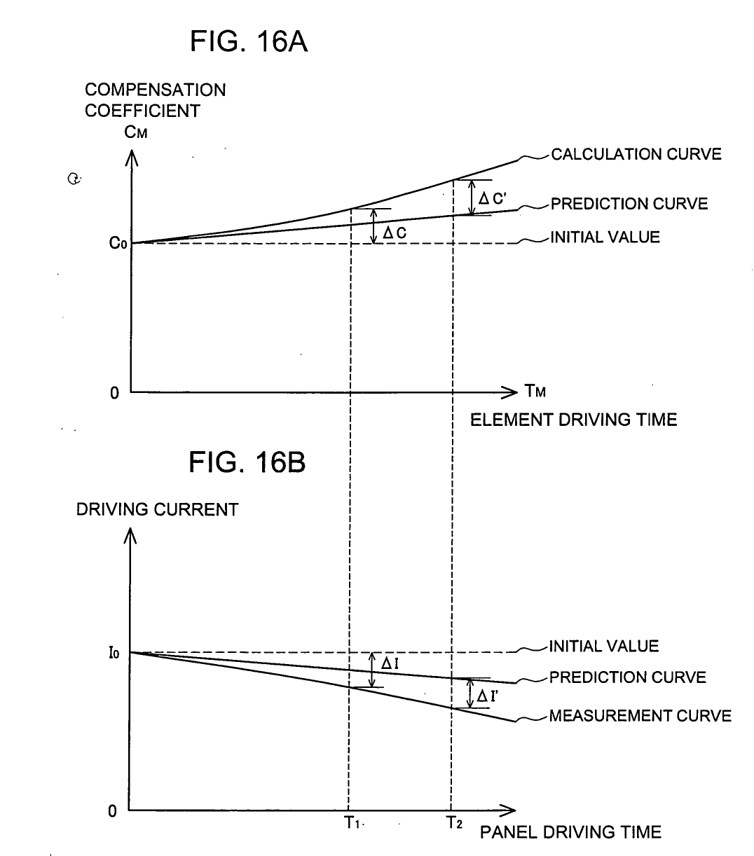

First, when the panel driving time reaches a predetermined elapsed time T₁, the compensation coefficient calculation unit 232 acquires from the signal measurement unit 24 the measured value I of the monitoring signal I_{S}, that is, the current I driving the monitoring emission element (step S11). Then, the difference ΔI (=I₀−I) between a predetermined reference value I₀ and the measured current I is calculated as the amount of degradation of the monitoring emission cell (step S12). Here, as the reference value I₀, the initial driving current at the time when driving of the monitoring emission element is begun may be adopted. FIG. 16B illustrates a graph of the driving current with respect to the panel driving time. In the graph, the measurement curve plots the measured value of the monitoring signal I_{S} (driving current I); the driving current I gradually declines from the initial value I₀ as the panel driving time elapses.

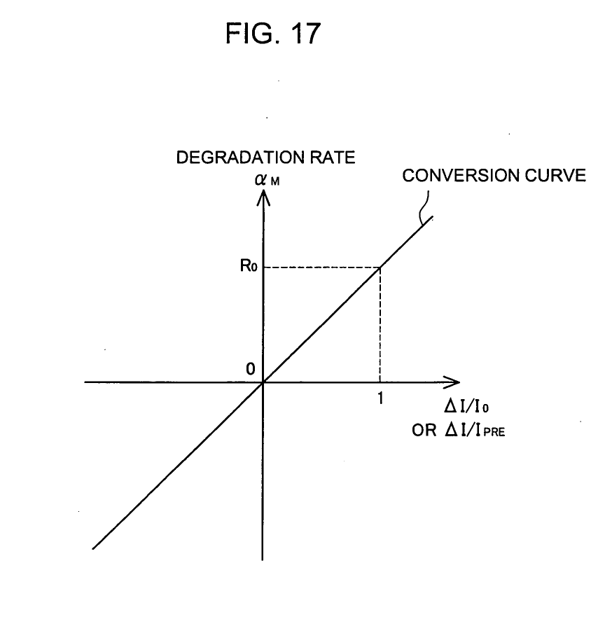

Next, the compensation coefficient calculation unit 232 sets the cell number M to the initial value (=1) (step S13), and then, referring to the degradation rate table (FIG. 17) stored in internal memory (not shown), calculates the degradation rate α_{M} of the M-th display cell (step S14). Specifically, the compensation coefficient calculation unit 232 calculates the ratio ΔI/I₀ of the amount of degradation ΔI to the reference value I₀, and can refer to the degradation rate table to calculate the degradation rate α_{M} for the ratio ΔI/I₀. The degradation rate table is prepared for each display cell, and the degradation rate α_{M} corresponding to the ratio ΔI/I₀ is calculated based on the conversion curve shown in FIG. 17 by an example. In the example of FIG. 17, a straight line of slope R₀ (=1) is adopted as the conversion curve.

Next, in step S15 the compensation coefficient calculation unit 232 uses the degradation rate α_{M} to calculate the compensation coefficient C_{M} for the M-th display cell. Specifically, the compensation coefficient C_{M} can be calculated according to the equation C_{M}=C₀×(1+α_{M}), where the coefficient C₀ is the initial value when the element driving time is zero, and can be set to the value “1”. The compensation coefficient C_{M} is obtained by adding the compensation value ΔC (=C₀×α_{M}) corresponding to the decline rate ΔI/I₀ for the driving current I to the initial value C₀.

In the next step S16, the compensation coefficient calculation unit 232 updates the stored contents of the table memory 22 by writing the compensation coefficient C_{M} of the M-th display cell corresponding to the panel driving time T₁ to the table memory 22. Then, in step S17 the compensation coefficient calculation unit 232 judges, for all display cells, whether the compensation coefficient C_{M} has been calculated. If processing to calculate the compensation coefficient has not been completed for all display cells, the compensation coefficient calculation unit 232 increments the cell number M (step S18), and repeats the procedure of step S14 for the M+1th display cell. If on the other hand compensation coefficient calculation processing is judged to have ended for all display cells in step S17, the compensation coefficient calculation processing ends. The above compensation coefficient calculation processing is repeated each time the panel driving time advances by a prescribed interval of time. FIG. 16A illustrates a graph representing an example of a calculation curve which plots the compensation coefficient C_{M} with respect to the element driving time T_{M} for the M-th display cell. Through the above compensation coefficient calculation processing, a calculation curve for the compensation coefficient C_{M} can be obtained from the measured curve of the driving current.

In this way, the monitoring emission element is constantly driven over a period of time to drive the organic EL panel 18C, and so is degraded in advance of the organic EL elements of display cells which are not constantly driven. The compensation coefficient calculation unit 232 calculates compensation coefficients at predetermined intervals to reflect the state of degradation of the monitoring emission element, and writes the compensation coefficients to the table memory 22 in association with the panel driving time. Hence compensation coefficients can be generated in advance of degradation of the organic EL elements of display cells, and can be written to the table memory 22.

The monitoring emission element is formed within the organic EL panel 18C together with other organic EL elements, and is driven under conditions similar to the driving conditions of the other organic EL elements, in ambient temperature during use. The compensation coefficient calculation unit 232 calculates compensation coefficients which reflect the state of degradation of the monitoring emission element under these conditions, so that the accuracy of compensation for the degradation of organic EL element characteristics can be improved.

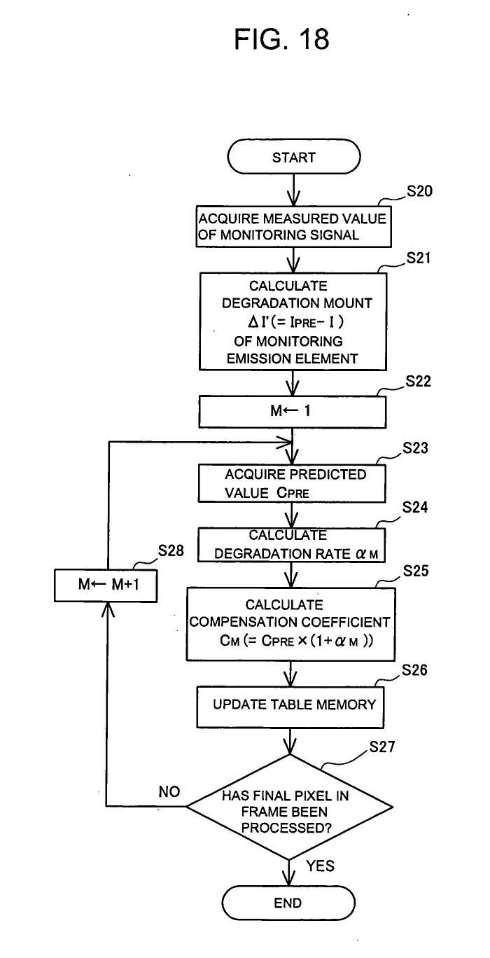

Next, second compensation coefficient calculation processing will be explained, referring to the flowchart of FIG. 18. First, when the panel driving time reaches a predetermined elapsed time T₂, the compensation coefficient calculation unit 232 acquires from the signal measurement unit 24 the measured value I of the monitoring signal I_{S}, that is, the current I driving the monitoring emission element (step S20), and then calculates, as the amount of degradation of the monitoring emission element, the difference ΔI′ (=I_{PRE}−I) between a predetermined predicted value I_{PRE} and the measured current I (step S21). As the predicted value I_{PRE}, the driving current of the monitoring emission element obtained at the time of inspection prior to manufacture of the image display apparatus 1C may be adopted. In FIG. 16B, a prediction curve which plots the predicted value I_{PRE} with respect to the panel driving time is shown. According to this prediction curve, the predicted value I_{PRE} declines gradually with the panel driving time starting from the initial value I₀.

Next, the compensation coefficient calculation unit 232 sets the cell number M to the initial value (=1) (step S22), and then refers to an internal memory (not shown) to acquire the predicted value C_{PRE} of the compensation coefficient for the M-th display cell (step S23). As the predicted value C_{PRE}, the compensation coefficient obtained at the time of inspection prior to manufacture of the image display apparatus 1C may be adopted. FIG. 16A illustrates a prediction curve which plots the predicted value C_{PRE} of the compensation coefficient with respect to the element driving time T_{M}. According to this prediction curve, the predicted value C_{PRE} rises gradually with the element driving time starting from the initial value C₀.

Next, in step S24 the compensation coefficient calculation unit 232 refers to the degradation rate table (FIG. 17) stored in an internal memory (not shown) and calculates the degradation rate α_{M} for the M-th display cell (step S24). Specifically, the compensation coefficient calculation unit 232 calculates the ratio ΔI′/I_{PRE} of the amount of degradation ΔI′ to the predicted value I_{PRE}, and calculates the degradation rate α_{M} for the ratio ΔI′/I_{PRE}, referring to the degradation rate table. The degradation rate table is prepared for each display cell, and the degradation rate α_{M} is calculated for the ratio ΔI′/I_{PRE} based on the conversion curve shown in FIG. 17 by an example.

In the next step S25, the compensation coefficient calculation unit 232 calculates the compensation coefficient C_{M} for the M-th display cell using the degradation rate α_{M}. Specifically, the equation C_{M}=C_{PRE}×(1+α_{M}) may be used to calculate the compensation coefficient C_{M}. The compensation coefficient C_{M} is obtained by adding the compensation value ΔC′ (=C_{PRE}×α_{M}) corresponding to the decline rate ΔI′/I₀ of the driving current I to the predicted value C_{PRE}.

In the next step S26, the compensation coefficient calculation unit 232 updates the stored contents of the table memory 22 by writing the compensation coefficient C_{M} of the M-th display cell to the table memory 22. Then, in step S27 the compensation coefficient calculation unit 232 judges whether the compensation coefficient C_{M} has been calculated for all display cells. If compensation coefficient calculation processing has not ended for all display cells, the compensation coefficient calculation unit 232 increments the cell number M (step S28), and repeats the procedure of step S23 for the M+1th display cell. If on the other hand it is judged in step S27 that processing to calculate the compensation coefficient has been performed for all display cells, compensation coefficient calculation processing ends. The above second compensation coefficient calculation processing is repeated each time the panel driving time advances by a prescribed interval of time.

Through the above second compensation coefficient calculation processing, similarly to the above first compensation coefficient calculation processing, the degradation rates of the organic EL elements in display cells can be predicted, and the compensation coefficients to be written to the table memory 22 can be generated. Further, compensation coefficients C_{M} are calculated based on the predicted value I_{PRE} of the driving current and the predicted value C_{PRE} of the compensation coefficient, so that the accuracy of prediction of the compensation coefficient C_{M} can be improved.

In the above, the image display apparatus 1C of the second embodiment has been explained. In this embodiment, the grayscale of image signals ID_{K} are adjusted prior to input to the data electrode drive unit 15. Similarly to the modified example of the first embodiment (FIG. 12), the configuration of the above second embodiment can also be modified such that the grayscale of image signals are adjusted after input to the data electrode drive unit 15.

3. Third Embodiment

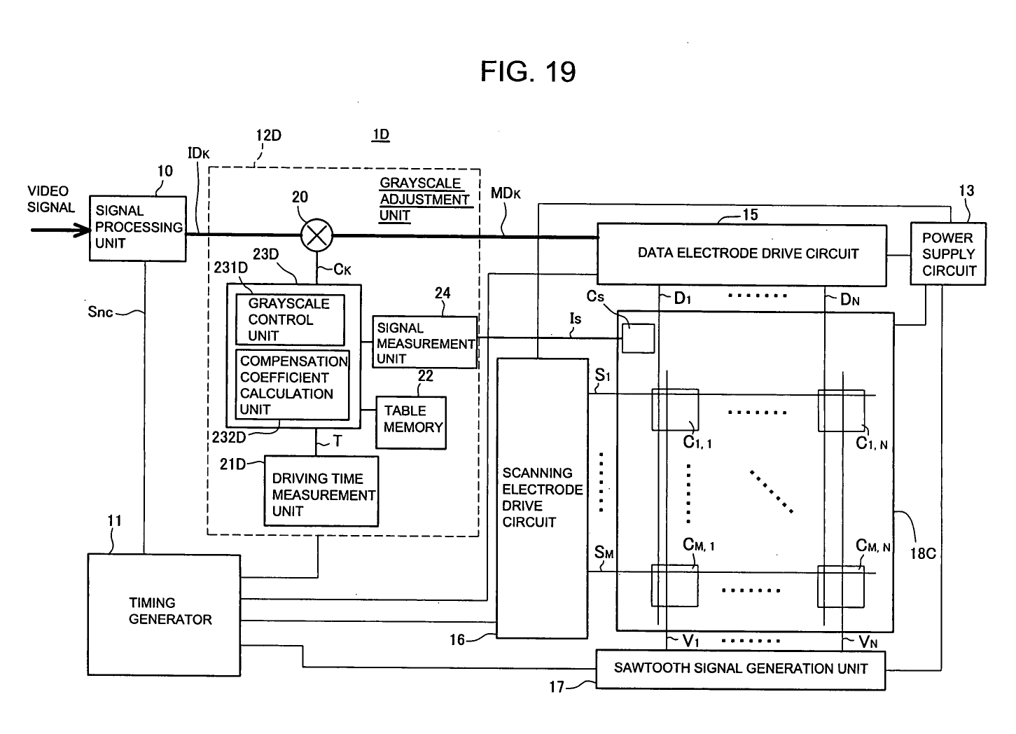

Next, a third embodiment of the invention will be described. FIG. 19 is a block diagram schematically illustrating the configuration of the image display apparatus 1D of the third embodiment. This image display apparatus 1D comprises a signal processing unit 10, timing generator 11, grayscale adjustment unit 12D, power supply circuit 13, data electrode drive unit 15, scanning electrode drive unit 16, sawtooth signal generator unit 17, and organic EL panel (display panel) 18C. In FIG. 19, constituent elements referred to by the same reference numeral as in FIG. 13 have the same configuration and same functions as the constituent elements of the first embodiment described above. Detailed explanation of such constituent elements is omitted.

The grayscale adjustment unit 12D comprises a multiplication circuit 20, control unit 23D, table memory 22, driving time measurement unit 21, and signal measurement unit 24. The control unit 23D comprises a grayscale control unit 231D and compensation coefficient calculation unit 232D. The grayscale control unit 231D executes grayscale control processing to acquire the panel driving time T from the driving time measurement unit 21D, acquire the compensation coefficient C_{K} corresponding to the acquired panel driving time T from the table memory 22, and apply these to the multiplication circuit 20. This grayscale control processing procedure is substantially the same as the grayscale control processing procedure of the above first embodiment (FIG. 8). However, in this embodiment, instead of the element driving time T_{K} in step S2 (FIG. 8), the panel driving time T is acquired, and in step S3 the compensation coefficient C_{M} corresponding to the panel driving time T is acquired. Through such grayscale control processing, adjustment processing such as illustrated in FIG. 9 through FIG. 11 is executed.

The driving time measurement unit 21D uses the clock signal provided by the timing generator 11 to measure the sum of the driving time for the organic EL panel 18C (where the sum hereinafter is referred to as “panel driving time T”), and supplies the measurement result to the control unit 23D.

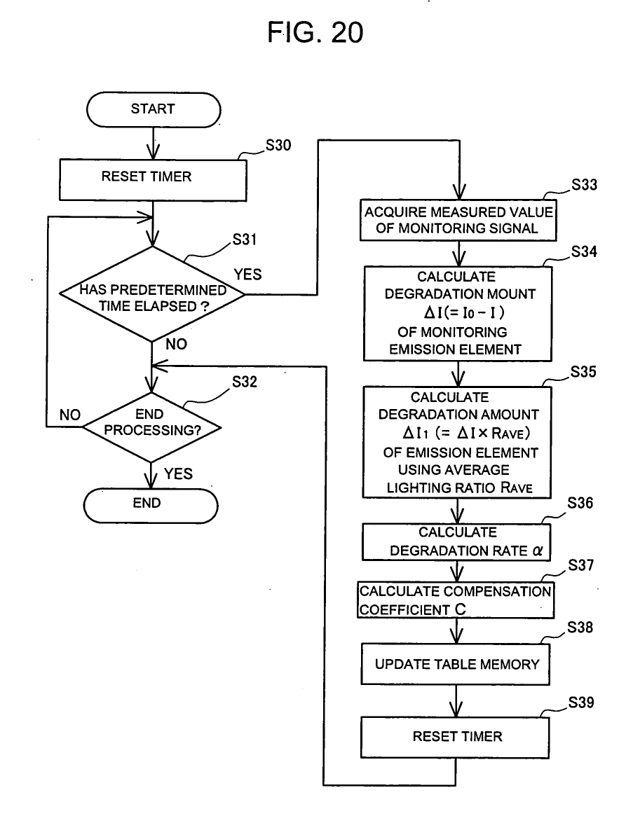

The compensation coefficient calculation unit 232D stores in advance, as an average lighting ratio R_{AVE}, a ratio of the average emission time of organic EL elements in the display cells C_{1,1} to C_{M,N}, to the panel driving time T. This “average emission time” means a predicted average value of the cumulative driving times of organic EL elements in the display cells C_{1,1} to C_{M,N}. For example, the average lighting ratio R_{AVE} of the organic EL elements can be set to 70%. The compensation coefficient calculation unit 232D uses this average lighting ratio R_{AVE} and the measured value I_{S} of the monitoring signal to execute compensation coefficient calculation processing, thereby calculating the compensation coefficient at each predetermined interval and storing the result in the table memory 22. Below, the compensation coefficient calculation processing will be explained in detail, referring to the flowchart of FIG. 20.

First, in step S30 the compensation coefficient calculation unit 232D resets an internal timer (not shown) at the start of driving of the organic EL panel 18C. As a result, the count value of the internal timer is reset to the initial value. Next, in step S31 the compensation coefficient calculation unit 232D compares a predetermined value stored in an internal register (not shown) with the count value of the internal timer to judge whether a predetermined time has elapsed. If it is judged that the count value has not reached the predetermined value, the compensation coefficient calculation unit 232D judges whether or not processing should be ended (step S32). If it is judged that processing should be ended, the above compensation coefficient calculation processing ends. If there is no judgment to end processing, the procedure returns to step S31. When the count value of the internal timer reaches the value of the internal register, in step S31 the compensation coefficient calculation unit 232D judges that the predetermined time has elapsed, and the procedure of steps S33 to S39 is executed.

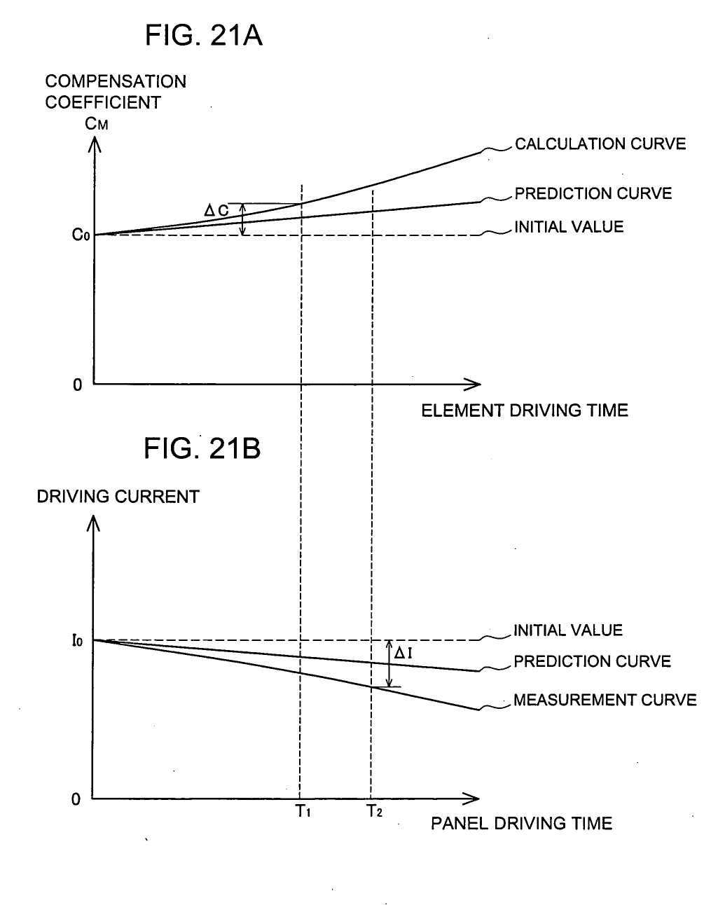

In step S33, the compensation coefficient calculation unit 232D acquires the measured value I of the monitoring signal I_{S}, that is, the current driving the monitoring emission element, from the signal measurement unit 24 (step S33), and then calculates, as the amount of degradation of the monitoring emission element, the difference ΔI (=I₀−I) between a predetermined reference value I₀ and the measured current I (step S34). As the reference value I₀, the initial driving current at the time when driving of the monitoring emission element is begun may be adopted. FIG. 21B illustrates a graph of the driving current with respect to the panel driving time. In this graph, the measurement curve plots the measured value (driving current I) of the monitoring signal I_{S}. The driving current I decreases gradually with panel driving time starting from the initial value I₀.

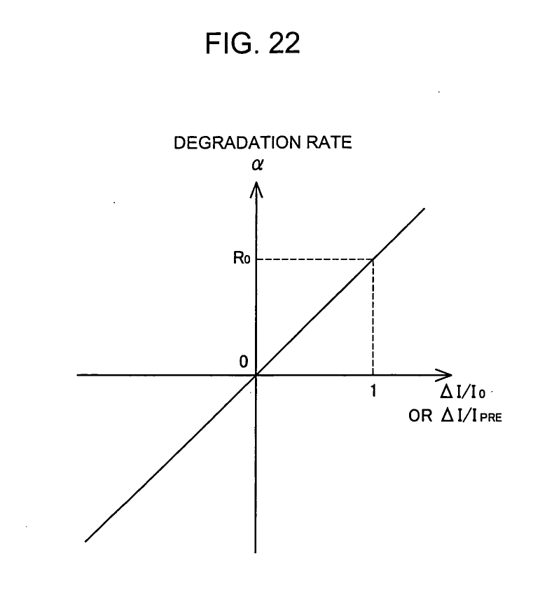

Next, the compensation coefficient calculation unit 232D uses the average lighting ratio R_{AVE} to calculate the amount of degradation ΔI₁ of the organic EL element (step S35). Then, the compensation coefficient calculation unit 232D refers to the degradation rate table stored in internal memory (not shown), and calculates the degradation rate a of organic EL elements using the degradation amount ΔI₁ (step S36). Specifically, as the degradation amount ΔI₁, the value obtained by multiplying the degradation amount ΔI of the monitoring emission element calculated in step S34 by the average lighting ratio R_{AVE} (=ΔI×R_{AVE}) can be adopted. The compensation coefficient calculation unit 232D calculates the ratio ΔI/I₀ of the degradation amount ΔI to the reference value I₀, and can calculate the degradation rate α corresponding to this ratio ΔI/I₀ by referring to the degradation rate table (FIG. 22). The degradation rate a corresponding to the ratio ΔI/I₀ is calculated according to the conversion curve shown in FIG. 22 by an example. Here, a straight line of slope R₀ (=1) is adopted as the conversion curve. In this way, by using the average lighting ratio R_{AVE}, the current amount of degradation ΔI₁ and degradation rate α of organic EL elements in display cells can be predicted from the degradation amount ΔI of the monitoring emission element which is driven constantly.

Next, the compensation coefficient calculation unit 232D calculates the compensation coefficient C (=C_{M}) using the degradation rate α (step S37), and updates the stored contents of the table memory 22 by storing this compensation coefficient C in the table memory 22 (step S38). Specifically, the compensation coefficient C may be calculated according to the equation C=C₀×(1+α). The compensation coefficient C is obtained by adding the compensation value ΔC (=C₀×α) corresponding to the decline rate ΔI/I₀ for the driving current I to the initial value C₀. Thereafter, the internal timer is reset (step S39), and the procedure proceeds to step S32.

Because the monitoring emission element is constantly driven over a period of time to drive the organic EL panel 18C, degradation proceeds in advance of that of the organic EL elements of the display cells C_{1,1} to C_{M,N} which are not constantly driven. The compensation coefficient calculation unit 232D uses this degradation amount ΔI of the monitoring emission element and the average lighting ratio R_{AVE} to predict the current degradation amount ΔI₁ of organic EL elements. Referring to FIG. 21B, if the compensation coefficient C is calculated when the panel driving time T is T₂, then this compensation coefficient C corresponds to the current element driving time T₁ of the organic EL elements of the display cells.

In the above compensation coefficient calculation processing, the difference between the initial value I₀ and the measured value I is used as the degradation amount ΔI of the monitoring emission element. In place of this, as showed in FIG. 21, the difference ΔI′ (=I_{PRE}−I) between the predicted value I_{PRE} of the driving current on the prediction curve and the measured value I can be calculated as the degradation amount of the monitoring emission element, and the degradation rate ΔI′/I_{PRE} can be calculated accordingly. Also, if a predicted value C_{PRE} on the prediction curve for the compensation coefficient is prepared in advance, this predicted value C_{PRE} can be used to calculate the compensation coefficient C (=C_{PRE}×(1+α)).

Thus according to the third embodiment, the monitoring emission element is constantly driven over a period of time to drive the organic EL panel 18C, and so is degraded in advance of degradation of the organic EL elements of the display cells which are not constantly driven. The compensation coefficient calculation unit 232 uses such degradation amounts ΔI and ΔI′ of the monitoring emission element and the average lighting ratio R_{AVE} to predict the current degradation rate a of the organic EL elements of display cells and generate compensation coefficients, so that degradation of the organic EL elements can be accurately compensated.

In the foregoing, various embodiments of this invention have been explained. In the above first through third embodiments, the organic EL elements formed in the organic EL panels 18, 18B, 18C are all driven with a constant voltage. The configurations of the above embodiments can be modified such that the organic EL elements are driven with the current held constant. For example, in the above second embodiment, a configuration may be substituted in which the emission elements of the monitoring cell C_{S} and the display cells C_{1,1} to C_{M,N} are driven with a constant current, the signal measurement unit 24 measures the driving voltage of the monitoring emission element, and the function of the compensation coefficient calculation unit 232 is to calculate the compensation coefficient in accordance with the increase in driving voltage with the passage of panel driving time.

It is understood that the foregoing description and accompanying drawings set forth the preferred embodiments of the invention at the present time. Various modifications, additions and alternatives will, of course, become apparent to those skilled in the art in light of the foregoing teachings without departing from the spirit and scope of the disclosed invention. Thus it should be appreciated that the invention is not limited to the disclosed embodiments but may be practiced within the full scope of the appended claims.

This application is based on a Japanese Patent Application No. 2003-364068, which is hereby incorporated by reference.

1. An image display apparatus for driving a display panel to cause light emission in response to an input image signal, comprising:
a display panel in which are arranged a plurality of display cells each having at least one emission element;
a driving unit which generates a data signal based on a grayscale value of said image signal and applies the data signal to said display cell to cause said emission element to emit light;
a driving time measurement unit which measures a cumulative driving time of said emission element;
a table memory which stores a compensation coefficient for compensation for aging of said emission element with respect to the cumulative driving time of said emission element; and
an adjustment circuit which uses said compensation coefficient from said table memory to adjust the grayscale value of said image signal, for each of said display cells.

2. The image display apparatus according to claim 1, further comprising a grayscale control unit which acquires said compensation coefficient from said table memory and applies the acquired compensation coefficient to said adjustment circuit,
wherein said driving time measurement unit uses the grayscale value of pixel data of said image signal to measure the cumulative driving time of said emission element for one or a plurality of said display cells, and said grayscale control unit acquires the cumulative driving time of said emission element from said driving time measurement unit, acquires one of said compensation coefficients corresponding to the cumulative driving time of the emission element, and applies the acquired compensation coefficient to said adjustment circuit.

3. The image display apparatus according to claim 2, wherein said grayscale control unit uses at least two of said compensation coefficients to obtain an interpolated compensation coefficient corresponding to said cumulative driving time acquired from said driving time measurement unit.

4. The image display apparatus according to claim 1, further comprising:
one or a plurality of monitoring emission elements formed on a substrate of said display panel, which emit light in response to a driving current;
a signal measurement unit which measures a monitoring signal indicating a current state of said monitoring emission element; and,
a compensation coefficient calculation unit which calculates said compensation coefficient at each predetermined interval based on said monitoring signal and stores the result in said table memory.

5. The image display apparatus according to claim 4, wherein said compensation coefficient calculation unit calculates a difference between the measured value of said monitoring signal and a predetermined reference value, calculates a value proportional to a ratio of said difference to said predetermined reference value, and further calculates said compensation coefficient using the calculated value as a degradation rate of said emission elements.

6. The image display apparatus according to claim 4, wherein said compensation coefficient calculation unit calculates a difference between the measured value of said monitoring signal and a predetermined prediction value, calculates a value proportional to a ratio of said difference to said predetermined prediction value, and further calculates said compensation coefficient using the calculated value as a degradation rate of said emission elements.

7. The image display apparatus according to claim 5, wherein said monitoring emission element is driven so as to constantly emit light over a period of time to drive said display panel, said driving time measurement unit measures the cumulative driving time of said display panel, and said compensation coefficient calculation unit stores, in said table memory, said compensation coefficient as a value corresponding to the cumulative driving time of the display panel.

8. An image display apparatus for driving a display panel to cause light emission in response to an input image signal, comprising:
a display panel in which are arranged a plurality of display cells each having at least one emission element;
a driving unit which generates a data signal based on a grayscale value of said image signal and applies the data signal to said display cell to cause said emission element to emit light;
a driving time measurement unit which measures a cumulative driving time of said display panel;
a table memory which stores a compensation coefficient for compensation for aging of said emission element with respect to the cumulative driving time of said display panel;
an adjustment circuit which uses said compensation coefficient from said table memory to adjust the grayscale value of said image signal, for each of said display cells;
one or a plurality of monitoring emission elements formed within said display panel, which emit light in response to a driving current;
a signal measurement unit which measures a monitoring signal indicating a current state of said monitoring emission elements; and
a compensation coefficient calculation unit which calculates said compensation coefficient at each predetermined interval based on said monitoring signal and stores said compensation coefficient in said table memory.

9. The image display apparatus according to claim 8, wherein
said compensation coefficient calculation unit stores in advance, as an average lighting ratio, a ratio of an average emission time of said emission elements to the cumulative driving time of said display panel;
said monitoring emission elements are driven so as to constantly emit light over a period of time to drive said display panel; and
said compensation coefficient calculation unit calculates a difference between the measured value of said monitoring signal and a predetermined reference value, multiplies said average lighting ratio by a ratio of said difference to said reference value to calculate a degradation rate of said emission element, and calculates said compensation coefficient using the degradation rate.

10. The image display apparatus according to claim 8, wherein
said compensation coefficient calculation unit stores in advance, as an average lighting ratio, a ratio of an average emission time of said emission elements to the cumulative driving time of said display panel;
said monitoring emission element is driven so as to constantly emit light over a period of time to drive said display panel; and
said compensation coefficient calculation unit calculates a difference between the measured value of said monitoring signal and a predetermined prediction value, multiplies said average lighting ratio by a ratio of said difference to said predetermined prediction value to calculate a degradation rate of said emission element, and calculates said compensation coefficient using the degradation rate.

11. The image display apparatus according to claim 4, wherein said driving unit causes said emission element and said monitoring emission element to emit light by driving at a constant voltage, and said signal measurement unit measures, as said monitoring signal, a driving current in said monitoring emission element.

12. The image display apparatus according to claim 4, wherein said driving unit causes said emission element and said monitoring emission element to emit light by driving at a constant current, and said signal measurement unit measures, as said monitoring signal, a driving voltage in said monitoring emission element.

13. The image display apparatus according to claim 1, wherein
each of said display cells comprises an active element which either supplies or halts a driving current to said emission element in response to an applied voltage; and
said driving unit generates said driving signal so as to provide said applied voltage varying in a pulse width depending on the grayscale value of said image signal adjusted by said adjustment circuit.

14. The image display apparatus according to claim 1, wherein said emission element includes an organic EL element.
